(19) United States
(12) Patent Application Publication
(10) Pub. No.: US 2024/0303889 A1
(43) Pub. Date: Sep. 12, 2024

(54) PASSIVE AND CONTINUOUS DEEP LEARNING METHODS AND SYSTEMS FOR REMOVAL OF OBJECTS RELATIVE TO A FACE

(71) Applicant: BLINK O.G. LTD., HAIFA (IL)

(72) Inventors: GILAD DROZDOV, HAIFA (IL); OREN HAIMOVITCH-YOGEV, HAIFA (IL)

(21) Appl. No.: 18/600,721

(22) Filed: Mar. 10, 2024

Related U.S. Application Data
(60) Provisional application No. 63/450,994, filed on Mar. 9, 2023.

(51) Int. Cl. G06T 11/60; G06V 10/82; G06V 40/16

(52) U.S. Cl. CPC G06T 11/60; G06V 10/82; G06V 40/168

(57) ABSTRACT

Methods, systems, and computer-readable media for generating realistic augmented face images are disclosed. Implementations include a) receiving head pose data, segmented eye region image data, eye position data, gaze direction data, and face and eye landmark data from an individual; b) receiving a user selection of a facial object to be added or removed from an image of the individual; and c) using a deep learning model, i) generating one or more images of the individual with the facial object in place on the one or more images, or ii) generating one or more images of the individual with the facial object removed from the one or more images.

### CROSS-REFERENCE TO RELATED APPLICATIONS

This application is a U.S. Non-Provisional patent application that claims priority to U.S. Provisional Patent Application No. 63/450,994 filed on Mar. 9, 2023, all of which is incorporated by reference herein in its entirety.

This application is related to co-owned U.S. patent application Ser. No. 16/732,640 filed on Jan. 2, 2020, titled “GEOMETRICALLY CONSTRAINED, UNSUPERVISED TRAINING OF CONVOLUTIONAL AUTOENCODERS FOR EXTRACTION OF EYE LANDMARKS” by Haimovitch-Yogev et al.; and co-owned U.S. patent application Ser. No. 17/376,388 filed on Jul. 15, 2021, titled “PUPIL ELLIPSE-BASED, REAL-TIME IRIS LOCALIZATION” by Drozdov et al.; and co-owned U.S. patent application Ser. No. 17/298,935 filed on Jun. 1, 2021, titled “SYSTEMS AND METHODS FOR ANATOMY-CONSTRAINED GAZE ESTIMATION” by Drozdov et al.; and co-owned U.S. patent application Ser. No. 17/960,929 filed on Oct. 6, 2022, titled “MULTI-USER GAZE TRACKING FOR PERSONALIZED RENDERING FROM A 3D DISPLAY” by Drozdov et al.; which are all hereby incorporated by reference herein in their entirety as though fully set forth herein, to the extent that they are not inconsistent with the instant disclosure.

### FIELD

The present application relates to generally to deep learning methods for the addition and removal of objects or pixels in face images, and more specifically to the use of head pose analysis and gaze-tracking for improved generation of augmented face images.

### BACKGROUND

Computer imaging methods and systems may be used to generate virtual face images, but challenges exist in the realistic and accurate removal or addition of features relative to a face image, for example relative to the face of a user of a display.

### SUMMARY

As described herein, it has been discovered that gaze tracking and/or head pose detection technology can improve the user experience with virtual face image generation by taking into account object type and characteristics in the encoding/decoding of neural networks for accurate removal or generation of the object.

Accordingly, the present application combines deep learning networks that include object characteristics, with gaze tracking and head pose analysis for improved accuracy in the placement of realistic objects on face images, or realistic removal of objects from face images.

Embodiments of the present disclosure include deep learning systems for face detection, face landmark detection including head pose analysis, and gaze tracking; as well as object characteristic information such as texture or reflectivity for use in training neural networks.

In one embodiment, a method includes a method for generating realistic augmented face images, the method comprising accepting face digital image data of one or more users, wherein the face digital image data includes at least head pose data, face and eye landmark data, eye localization data, and gaze direction data; accepting segmented eye region image data of the one or more users; accepting facial object information; using the face digital image data, the segmented eye region image data, and the facial object information to train a deep neural network to encode and decode at least one facial object characteristic, wherein the deep neural network is operable to reconstruct the at least one facial object characteristic post-training; receiving inference head pose data, inference segmented eye region image data, and inference face digital image data from an individual; receiving a user selection of at least one inference facial object; and generating one or more images of the individual with the inference facial object in place on the image, wherein the one or more images of the individual with the inference facial object in place on the image includes an inference of facial object appearance derived from the deep neural network based on the user head pose data, segmented eye region image data, face digital image data, and the user selection of at least one inference facial object.

In another embodiment, a method includes a method for removing an object from one or more images of a face, the method comprising accepting face digital image data of a user, wherein the face digital image data includes at least head pose data, face and eye landmark data, eye position and gaze direction data; accepting segmented eye region image data of the user; accepting facial object information; using the face digital image data, the segmented eye region image data, and the facial object information to train a deep neural network to encode and decode at least one face object region; wherein the deep neural network is operable to replace at least one face region image having a face object with a face region image without the face object post-training; receiving inference face digital image data and inference segmented eye region image data from an individual; receiving a user selection of at least one inference facial object; and generating one or more images of the individual without the inference facial object, wherein the one or more images of the individual without the inference facial object includes an inference of face appearance derived from the deep neural network based on the user face digital image data, the segmented eye region image data, and the user selection of at least one inference facial object.

In yet another embodiment, a method includes a method for generating realistic augmented face images, the method comprising receiving head pose data, segmented eye region image data, eye position data, gaze direction data, and face and eye landmark data of an individual; receiving a user selection of a facial object to be added or removed from an image of the individual; and using a deep learning model, a) generating one or more images of the individual with the facial object in place on the one or more images, or b) generating one or more images of the individual with the facial object removed from the one or more images, wherein the generated one or more images of the individual with the facial object in place or removed includes an inference of facial object appearance or disappearance derived from the deep learning model; and wherein the deep learning model was trained at least in part on head pose data, face and eye landmark data, eye position data, gaze direction data, segmented eye region image data, and facial object information.

### BRIEF DESCRIPTION OF THE FIGURES

FIG. 1 depicts a flow diagram of method operations according to the instant application.

FIG. 2 depicts a system environment depicting three approaches for training networks for face object generation and removal according to the instant application.

FIG. 3 depicts a high-level flow illustrating components and functions of a multiple VQ-VAE architecture for face object rendering according to the instant application.

FIG. 4 depicts additional details of the VQ-VAE encoder-decoder architecture described in FIG. 3.

FIG. 5 depicts a categorical encoder system according to the instant application.

FIG. 6 depicts a flow diagram of an example training process for neural networks according to the instant application.

FIG. 7 depicts an example of virtual face object removal according to the instant application.

FIG. 8 depicts a deep learning approach for virtual face object generation and removal according to the instant application.

FIG. 9 depicts another example deep learning approach for virtual face object generation and removal according to the instant application.

FIG. 10 depicts a deep learning architecture for face landmark detection.

FIGS. 11A, 11B, and 11C show component flows of a face landmark detection network according to the present disclosure.

FIG. 12 depicts a component flow of the landmark detection network according to the present disclosure.

### DETAILED DESCRIPTION

Embodiments of the present disclosure include realistic object generation and/or removal from a face image, for example, a mask, facial hair feature, eyeglasses, or eyeglass lens reflection. Other objects that may be generated or removed include hats, caps, visors, surgical caps or masks, safety glasses, protective glasses, headsets, goggles, or eye patches. Accurate object generation and placement can enhance any image of a face, and the deep learning methods and systems disclosed herein result in realistic placement and rendering of objects, or their removal. It is envisioned herein that an accurate rendering of augmented virtual face images is made possible through neural network training that includes object characteristic information for realistic object appearance, as well as eye tracking and head pose analysis to provide positioning guidance.

Implementations described herein provide a viewer experience that is enhanced by rendering pixels that realistically show a virtual object, or face pixels in place of an object to be removed virtually. According to embodiments herein, generating or removing objects virtually from a face image is achieved by obtaining object information about an object to be removed virtually, as well as gaze and head pose information. Trained neural networks are then used to calculate point-of-regard for each viewer, and virtual face images can be rendered based on the object to be added or removed, and the viewer's head pose and point-of-regard.

In some embodiments, a deep neural network is trained that will encode the texture of a lens. Using an encoder/decoder, images will be fed through the layers, and then the network will reconstruct the image. This results in the ability of the network to generate many types of lenses and coatings. In the training process, it is not necessary to label images, but information about the type of image is helpful.

For virtual object removal, such as virtual eyeglasses removal from a face, the network will detect the face and eyeglasses lens region, and virtually excise the eyeglasses lens region pixels for substitution with pixels of the eye patch without eyeglasses. In this example, the inference draws upon the geometry of the face and eyes to provide the virtual glasses-free image.

For virtual object generation, for example, with eyeglasses, information is needed about the lens and frame, for example, lens color, lens coating type, frame dimensions, and frame color. A neural network is then given the position of the head, the image of face, lens and frame information, and then the network will output an image of the face with glasses on, with realistic reflections. Head pose and gaze tracking information will inform an inference that gives the correct positioning of the glasses on the face with accurate reflections that take into account head pose and light source(s).

In the training phase, for generation of eyeglasses, we primarily are concerned with the lens patch, and images or videos that only include eyeglasses. Therefore, input data for training can exclude images and videos of faces that do not have eyeglasses. In some embodiments, input data may include images or sequences of images, head pose, frame shape, frame color, lens color and reflection, and eye pose. In some embodiments the information may be used to control rendering and movements of a digital twin of a user, for example, a digital avatar of the user.

In some embodiments, the neural network may generate one or more virtual eyeglass lenses for a face, including color, coating effects, reflections, and degree of refraction corresponding to a corrective prescription for the virtual lens or lenses.

The use of face landmarks in the instant methods and systems allows for a large number of pixels to be discarded, resulting in lower latency and reduced computing requirements. For example, this may obviate the need to send video images. In a video communications or metaverse (virtual world) context, face landmarks as described below may reduce demands on the system, reserving bandwidth and computational resources for other things.

In terms of neural network training, user ranking of output may be used, including supervised learning methods. In some embodiments, the system may possess unique ground truth, e.g., in the eyeglasses case where the facial object is a pair of eyeglasses, the system knows what glasses the user bought and if he/she/they is happy with the optical correction for this frame. In some cases there may also be a fitting measurement data for that person. See, e.g., U.S. patent application Ser. No. 17/340,333, titled “System and Method for Fitting Eyewear,” filed on Jun. 7, 2021, with inventors David, Drozdov, and Mizrahi, incorporated herein by reference.

User feedback may take the form of like/dislike, preference, ranking of images, verbal feedback, or other means. In some embodiments, as discussed below, the system may be connected to a large language model such as ChatGPT, which enables a voice or text input from the user to comment on a given inference output image. This feedback can be added to the feed forward calculations of the neural network to improve the results online.

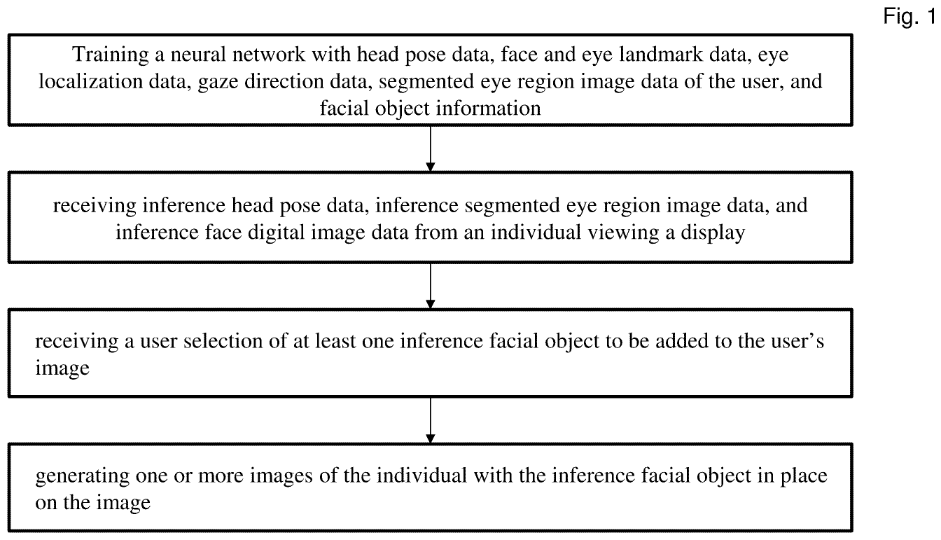

FIG. 1 depicts a flow diagram of a series of method operations, including training a neural network with head pose data, face and eye landmark data, eye localization data, gaze direction data, segmented eye region image data of one or more users, and facial object information; receiving inference head pose data, inference segmented eye region image data, and inference face digital image data from an individual viewing a display; receiving a user selection of at least one inference facial object to be added to the user's image; and generating one or more images of the individual with the inference facial object in place on the image.

In this and the following examples, inference head pose data, inference segmented eye region image data, and inference face digital image data refer to information to be used by the trained neural network or deep learning model to perform inference or image generation. For example, when a user provides their face image to be used as the baseline or reference for an augmented or virtual image of it, the information contained in that baseline or reference face image may include “inference” head pose data, “inference” segmented eye region image data, or “inference” face digital image data.

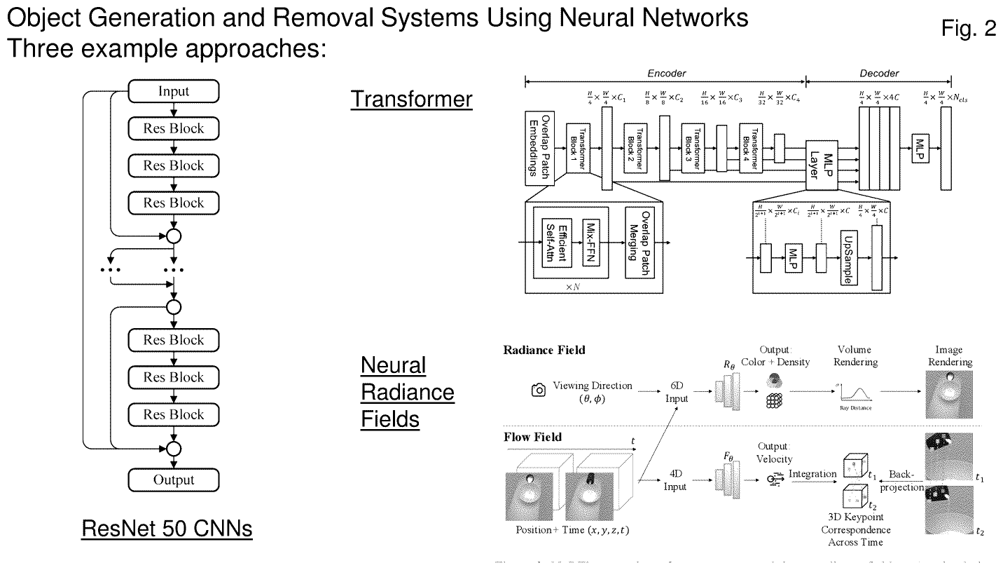

FIG. 2 depicts example diagrams of three deep learning models that may be used to achieve virtual face object generation and removal according to the instant application. Shown are a ResNet 50 CNN-based schema, a transformer-based schema, and a neural radiance field-based schema.

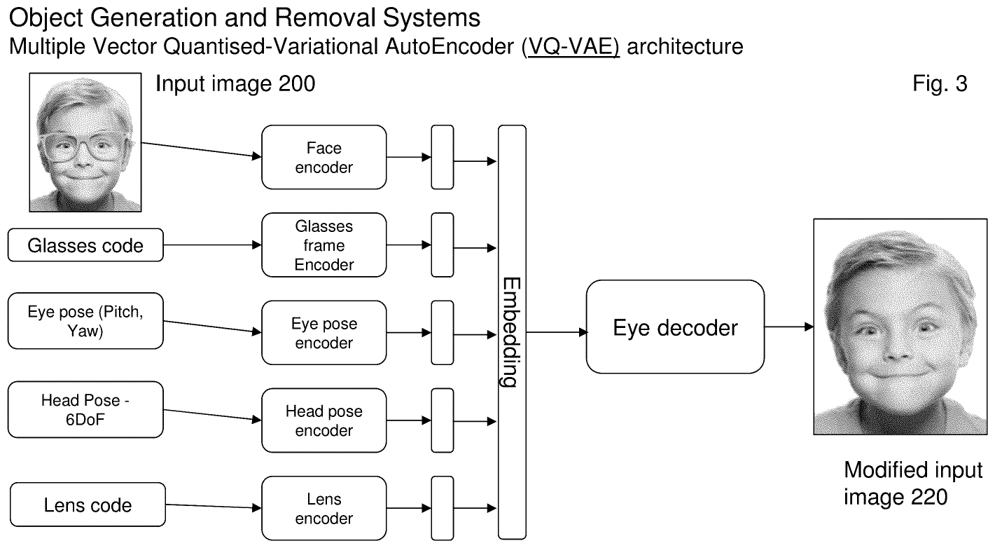

FIG. 3 depicts a multiple vector quantised-variational autoencoder (VQ-VAE) architecture (See https: //arxiv.org/pdf/1711.00937v2.pdf, incorporated by reference herein), which may include the following elements:

A face encoder, for example a convolutional neural network such as ResNet51.

An eyeglasses/frame encoder, for example a lookup table that maps an eyeglasses frame serial number (e.g., an 8-digit unique identifier) to a feature vector to be learned at training time.

An eye pose encoder, in which eye pose or gaze direction may be estimated from an input image using, for example, convolutional neural network systems for gaze estimation described in U.S. patent application Ser. No. 17/298,935 filed on Jun. 1, 2021, titled “SYSTEMS AND METHODS FOR ANATOMY-CONSTRAINED GAZE ESTIMATION” by Drozdov et al., hereby incorporated by reference.

A head pose encoder, in which head pose using, for example, the methods described in U.S. patent application Ser. No. 17/960,929 file on Oct. 6, 2022, titled “MULTI-USER GAZE TRACKING FOR PERSONALIZED RENDERING FROM A 3D DISPLAY” by Drozdov et al., hereby incorporated by reference.

Additional deep learning blocks may use a bounding box for a face patch to perform facial analysis to generate a set of facial landmarks for the input image.

Additional deep learning blocks may use eye region data and head pose data to perform dynamic facial analysis to generate eye localization, eye state, point of regard, gaze direction, and eye patch information.

A lens encoder, for example a lookup table that maps a serial number of a lens or lens coating (e.g., an 8-digit unique identifier) to a feature vector to be learned at training time.

Following embedding, the eye decoder provides the information for rendering a modification of the input image.

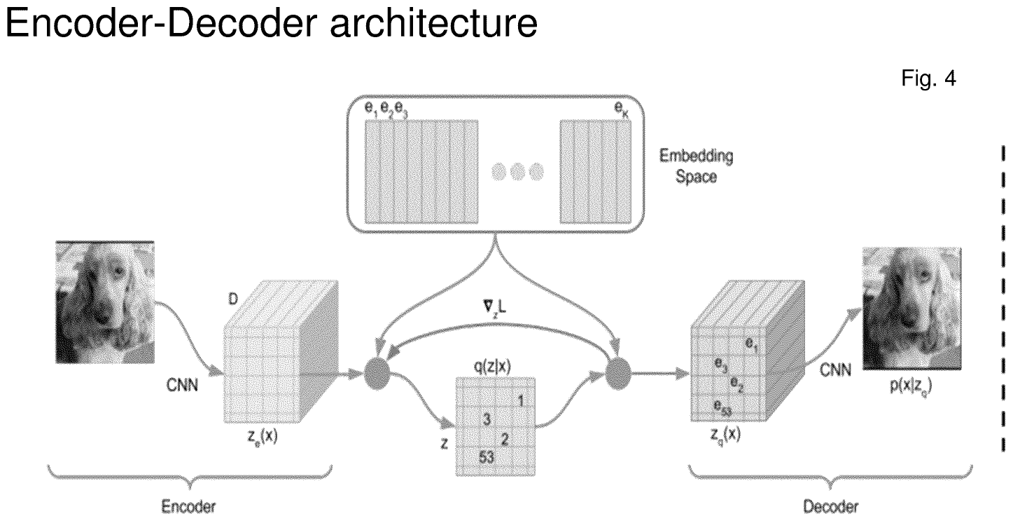

FIG. 4 depicts additional details of the encoder-decoder architecture described in FIG. 2. Based on the multiple VQ-VAE architecture, each input has its own encoder, and all share the same decoder. In this embodiment, the input image is provided to the encoder, here a CNN—Resnet50 (see https: //arxiv.org/abs/1512.03385, incorporated by reference herein), and the decoder is a PixelCNN decoder. See https: //arxiv.org/pdf/1606.05328.pdf and https: //paperswithcode.com/method/pixelcnn, both incorporated by reference herein.

Returning to FIG. 4, the system may use deep learning to model the whole left eye and whole right eye, as well as the position of the eyes relative to the display, and eye state, gaze angle, and point of regard.

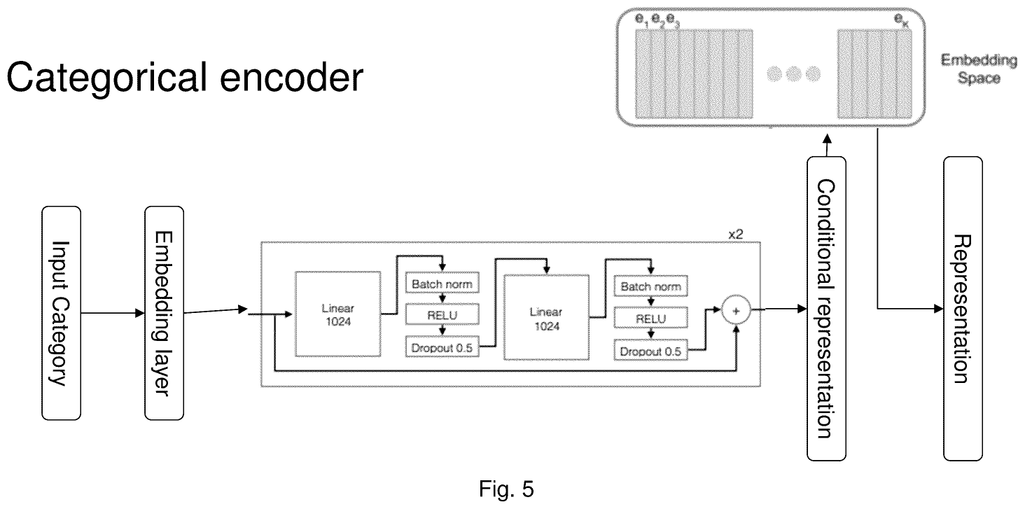

FIG. 5 depicts a categorical encoder system embodiment including the embedding layer and multilayer perceptron (e.g., a fully connected feedforward neural network (‘MLP’)) for converting categorical data into integer format so that the data with converted categorical values can be provided to the models to improve inference performance based on category input for various face objects.

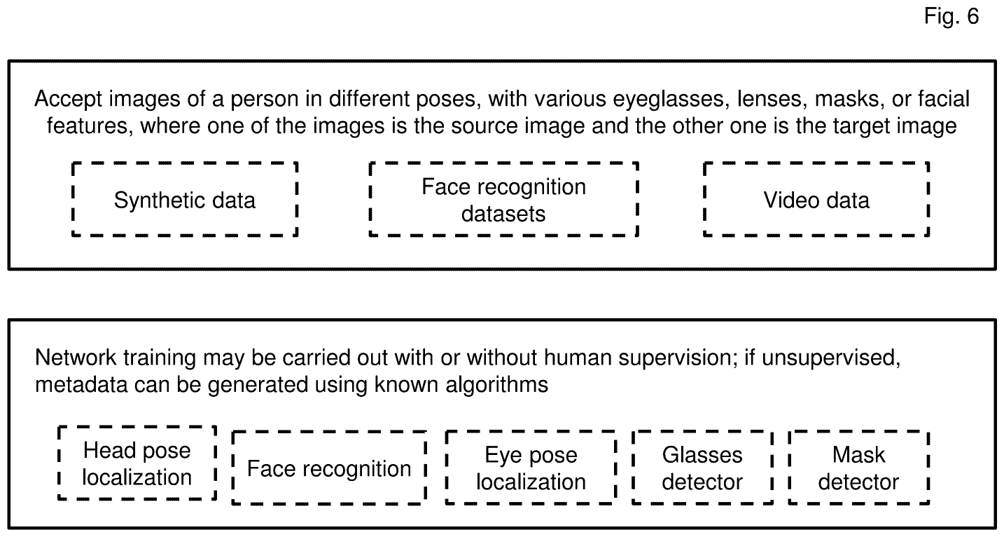

FIG. 6 depicts example operations for training neural networks to add or remove face objects. In one embodiment, the system may accept images of a person in different poses, with various eyeglasses, lenses, masks, or facial features, where one of the images is the source image and the other one is the target image. Training data may be taken from face recognition datasets or video data, such as YouTube video data or other internet video data. Synthetic data may also be used, alone or in combination with the above data types.

Network training may be carried out with or without human supervision; if unsupervised, metadata can be generated using known algorithms, e.g., those for face recognition, head pose localization, and eye pose localization. For glasses detectors, an assumption may be made that no two glasses are the same.

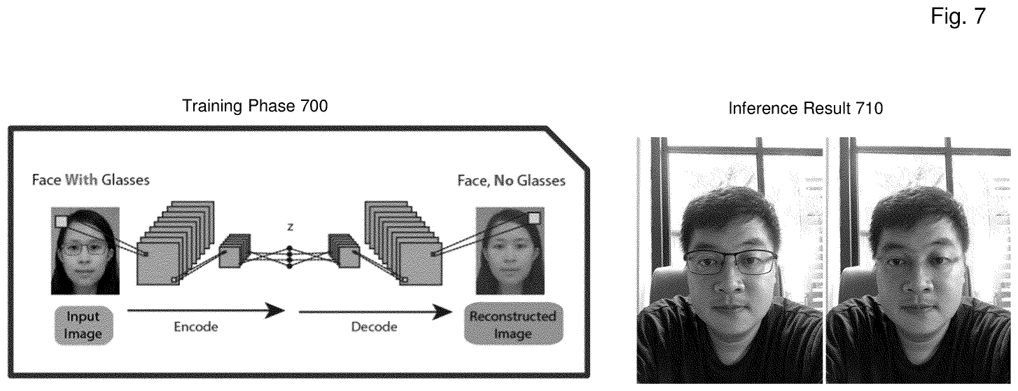

FIG. 7 depicts an example embodiment of virtual face object removal according to the present application. In this example, a training phase 700 is depicted on the left, and an inference result 710 is depicted on the right. In some embodiments, the system may generate a full 3D-digital human or human face for full immersive face object placement on the face, e.g., precision fusion of eyeglasses including frame and lenses with the face and eyes, as shown in inference result 710. As can be seen in this figure, using our face-encoding CNN, we can implement a glasses removal procedure and then super-impose pre-defined 3D frames back onto the face image. This allows people who wear glasses, and who therefore require vision correction to virtually substitute their glasses with another pair without losing their vision correction.

In some embodiments, any eyeglasses characteristic may be modified, simulated, or removed in the inference face image, such as frame color, texture, lens coating appearance, frame or lens reflections, lens refraction appearance, or any other visible eyeglasses characteristic.

Similarly, any face covering characteristic may be modified, simulated, or removed, e.g., added, changed, or removed, including masks, facial hair, glasses, eyepatches, visors, hats, makeup, tattoos, or jewelry.

Further, any plastic surgery effect may be modified, simulated, or removed, including wrinkles, face feature size (e.g., nose or chin), hairline placement, face contour, skin fold, hair characteristic, skin appearance, or other visible face characteristic.

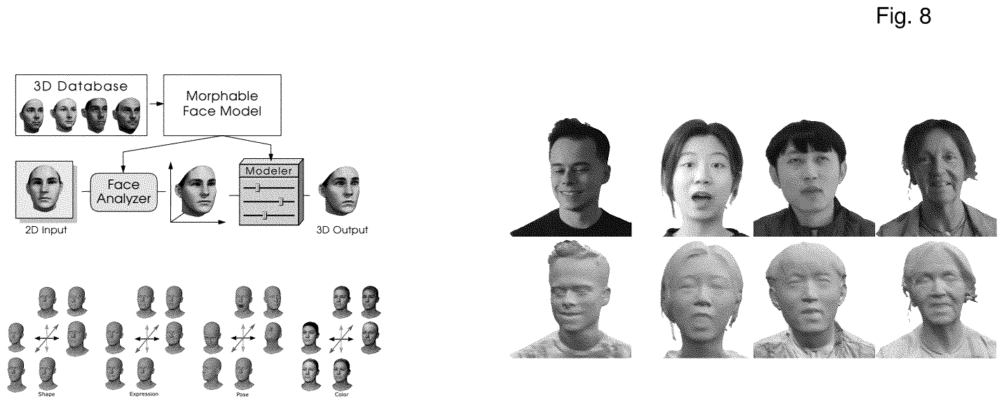

FIG. 8 depicts a deep learning model using implicit morphable 3D face models from video capture (3DMM). This approach involves the generation of a personalized virtual facial shape, pose and expression. Fusion of 3DMM methods and neural radiance fields can be carried out to determine shape, expression, pose and color intensity for the face models. Dense facial landmarks and head pose are used to generate a controllable generalized model of the individual without, for example, eyeglasses, lenses, or frames.

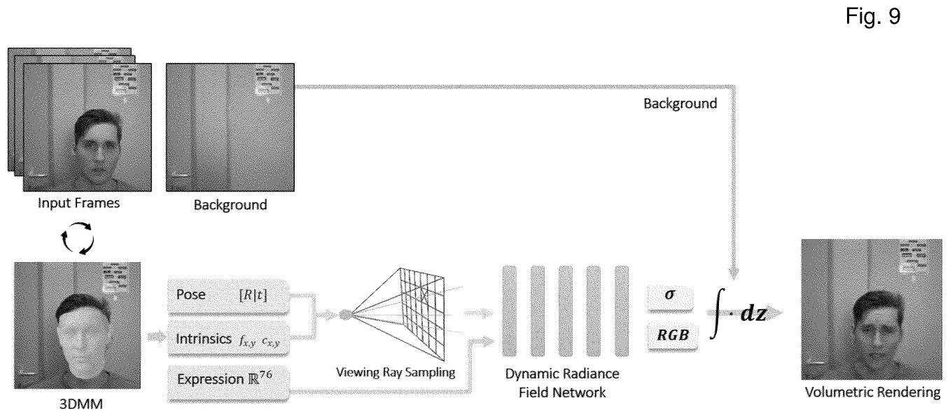

FIG. 9 depicts additional details about 3DMM and neural radiance field approaches for face object generation and removal. Here, the network learns how each voxel (X,Y,Z) from view (Theta, Phi) will appear in RGB and density parameter Sigma. This is computed for each voxel, and all viewing angles, leading to a complete 3D representation of the face (and face object if desired).

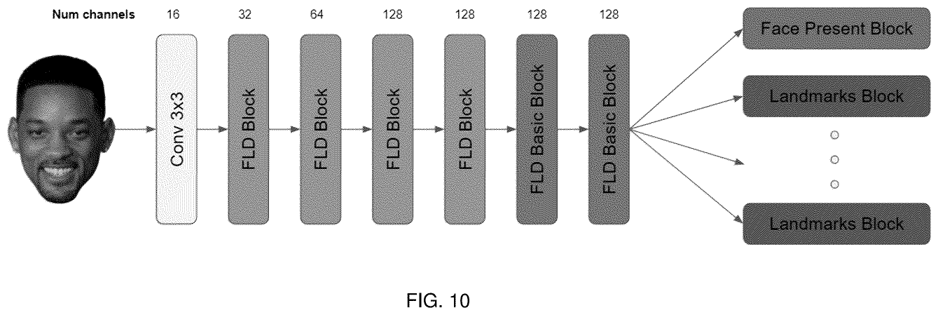

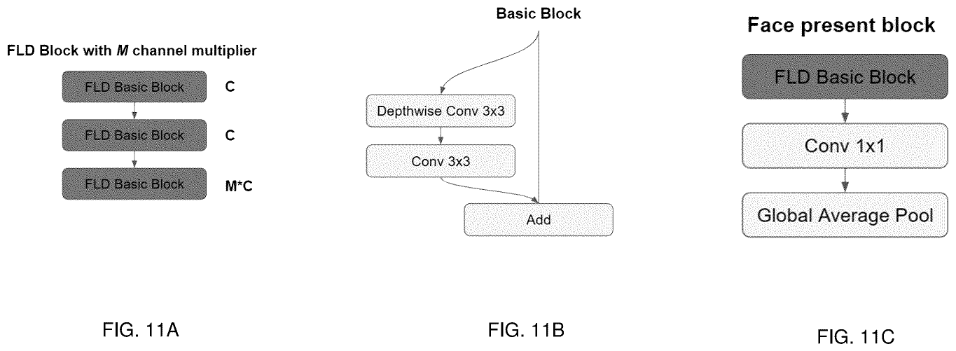

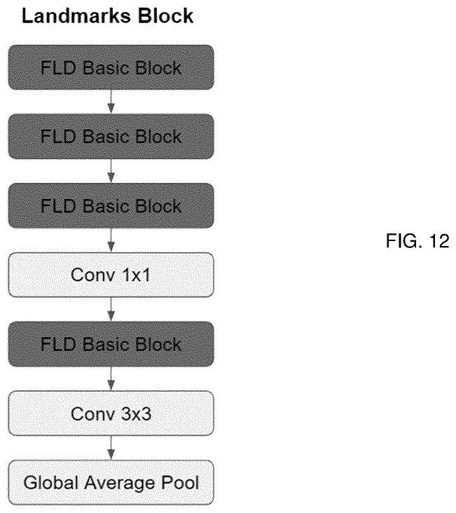

FIGS. 10-12 show example landmark generation and flows according to the methods described herein.

In some embodiments, a deep gaze unit may be implemented to determine eye localization, eye state detection (e.g., blinks, eye movements, or eye fixations), gaze estimation, and assigning a digital ID to the face/eyes of each viewer. In an example, face identification may accommodate situations in which a viewer's face is obstructed (e.g., if a viewer is wearing a mask or is wearing glasses).

Post-processing may include view selection, view optimization, camera-screen calibration, and user-specific calibration. View optimization may be based on parameters from neural networks such as DNNs or CNNs for gaze detection, or from user-specific calibration.

Further, the methods and systems disclosed herein may include detecting face and eye landmarks for the one or more viewers in one or more image frames based on the face digital image data. In some embodiments, the eye region image data may include at least one of pupil image data, iris image data, or eyeball image data.

With respect to 3D eye position, it may include the distance of the viewer's eye from a display, or the location of the viewer's eyeball(s) in an x, y, z coordinate reference grid including the display. Accordingly, the 3D eye position may refer to the position of one or more viewer's eyes in space, for example based on the viewer's height. Gaze angle may vary based on whether the viewer is looking up, down, or sideways. Both 3D eye position and gaze angle may depend at least in part on the viewer's physical characteristics (e.g., height), physical position (e.g., standing or sitting), and head position (which may change with movement).

Point-of-regard refers to a point on the display that the viewer's eye(s) are focused on, for example, the position of rendered content being viewed by the viewer's eyes at a given point in time. Point-of-regard may be determined based on gaze tracking, the position of content being rendered, focus of the content, and viewer selection.

In some embodiments, gaze angle may include yaw and pitch. Yaw refers to movement around a vertical axis. Pitch refers to movement around the transverse or lateral axis. In some embodiments, the analyzing the eye region image data further comprises analyzing at least one eye state characteristic. In some embodiments, the eye state characteristic comprises at least one of a blink, an open state being either a fixation or a saccade (movement), or a closed state. The open state refers to an eye being fully open or at least partially open, such that the viewer is receiving visual data. The closed state refers to fully closed or mostly closed, such that the viewer is not receiving significant visual data. In some embodiments, the acquiring eye region image data may be performed by a camera at a distance of at least 0.2 meters from the plurality of viewers. It is noted, however, that the viewer(s) may be located at any suitable distance.

In some embodiments, accepting face digital image data may be performed by at least one of a laptop camera, tablet camera, a smartphone camera, a digital billboard camera, or a digital external camera. In some embodiments, accepting face digital image data may be performed with active illumination. In some embodiments, accepting face digital image data may be performed without active illumination. In some embodiments, gaze direction data may include or be obtained by mapping the eye region image data to a Cartesian coordinate system and unprojecting the pupil and limbus of both eyeballs.

In some embodiments, the method may include determining head pose information based on the face image data and eye region image data.

In some embodiments, the method may include determining eye tracking information for each of the one or more viewers based on the face image data, eye region image data, and head pose information, the eye tracking information including a point of regard (PoR) of each eye of each of the one or more viewers, eye state of each eye of each of the one or more viewers, gaze direction of each eye of each of the one or more viewers, eye region illumination information for each eye of each of the one or more viewers, and a position of each eye of each of the one or more viewers relative to a display.

In some embodiments, eye region image data may be mapped to a Cartesian coordinate system. The Cartesian coordinate system may be defined according to any suitable parameters, and may include for example, a viewer plane with unique pairs of numerical coordinates defining distance(s) from the viewer to the image plane. In some embodiments, the method may include unprojecting the pupil and limbus of both eyeballs into the Cartesian coordinate system to give 3D contours of each eyeball. Unprojecting refers to defining 2D coordinates to a plane in a 3D space with perspective. In an example, a 3D scene may be uniformly scaled, and then plane may be rotated around an axis and a view matrix computed.

In some embodiments, the method may include acquiring eye region image data of a plurality of viewers within a field of view of at least one camera associated with a digital display. The field of view may be defined in two-dimensional or three-dimensional space, such as from side-to-side, top-to-bottom, and far or near. The method may include analyzing the eye region image data to determine at least one 3D eye position, at least one gaze angle, and at least one point-of-regard for at least one viewer relative to at least one camera associated with the digital display, from which to estimate gaze direction or PoR. Input from more than one source (e.g., multiple cameras) may be received. In some embodiments, the method may include analyzing the eye region image data for at least one of engagement with the digital display, fixation, or saccade. In some embodiments, the method may include assigning an identifier to each face, one for each respective viewer. This operation may occur at any point in the method, but preferably before or near the time that eye region image data for each viewer is acquired, so that the eye region image data for each viewer may be associated with that viewer's identifier in order to personalize the rendering for each specific viewer.

In some embodiments, gaze angle may be determined, e.g., by yaw and pitch parameters. Yaw and pitch may change as the viewer moves their eye, their head, or their position (e.g., moving side-to-side or toward or away from a camera or display). In some embodiments, analyzing the eye region image data may include analyzing at least one eye state characteristic. In some embodiments, the eye state characteristic comprises at least one of a blink, an open state being either fixation or saccade, or a closed state. Blink may be defined by a threshold. For example, the eye state characteristic may ignore routine eye blinks, but trigger on multiple and/or slow eye blinks. In some embodiments, accepting eye region image data may be performed by a camera at a distance of at least 0.2 meters from at least one user or individual.

In some embodiments, methods and systems of the present application may include calculating a distance between at least one camera and at least one viewer using image analysis (See, e.g., K. A. Rahman, M. S. Hossain, M. A.-A. Bhuiyan, T. Zhang, M. Hasanuzzaman and H. Ueno, “Person to Camera Distance Measurement Based on Eye-Distance,”2009 Third International Conference on Multimedia and Ubiquitous Engineering, 2009, pp. 137-141, doi: 10.1109/MUE.2009.34; https: //ieeexplore.ieee.org/document/5319035.

### Transformer Network Embodiments

In some embodiments, artificial intelligence systems may be employed that take advantage of transformer technology. Vision transformers in AI are deep learning models that, among other things, use self-attention algorithms to differentially weight the significance of various input data. Transformers measure the relationships between pairs of input tokens (pixels in the case of images; words in the case of text strings), termed attention. The cost is quadratic in the number of tokens. Notably, computing relationships for every pixel pair in a typical image is prohibitive in terms of memory and computation. Instead, vision transformers compute relationships among pixels in various small sections of the image (e.g., 16×16 pixels), at a drastically reduced cost. The sections (with positional embeddings) may then be placed in a sequence. The embeddings are learnable vectors. Each section is typically arranged into a linear sequence and multiplied by the embedding matrix. The result, with the position embedding, is then fed to the transformer.

In some embodiments, a transformer may be used with a convolutional neural network (CNN) stem/front end, in a hybrid system. For example, a vision transformer stem may use a 16×16 convolution with a 16 stride. By contrast, a 3×3 convolution with stride 2, may increase stability and improves accuracy. The CNN translates from the basic pixel level to a feature map. A tokenizer may then translate the feature map into a series of tokens that are then fed into the transformer, which applies the attention mechanism to produce a series of output tokens. Finally, a projector may reconnect the output tokens to the feature map. The latter allows the analysis to exploit potentially significant pixel-level details, reducing the number of tokens that need to be analyzed, reducing compute costs accordingly.

In some embodiments, training may be supervised, unsupervised, or self-supervising. In self-supervising learning (SSL) embodiments, an SSL process may involve learning supervisory signals (e.g., labels generated automatically) in a first stage, which are then used for some supervised learning task in later stages. In these embodiments, SSL represents a hybrid form of unsupervised and supervised learning. See https://www.youtube.com/watch?v=-lnHHWRCDGk&t=759s; Christopher Potts seminar, Jan. 31, 2023.

### In-Context Learning Models and Text/Voice-to-Image AI

One approach to image AI training is to create a data set of positive and negative examples of each class of objects of interest, and then train a custom-built model to make the binary distinction reflected in the labels as to whether or not the image has an object, or whether the image has an object with the right appearance. This approach can be powerful, but it has some limitations in terms of the diversity of objects and appearances of objects. Different classes of objects may need separate data sets and maybe separate models for, say, eyeglasses and masks.

But with in-context learning, a single, big, frozen object model trained on a large corpus of, say google images, may be able to scale to all classes of facial objects and appearances of those objects.

With this approach, given examples of images with positive and negative instances of objects of interest, the network may learn in-context about the distinction represented by the positive and negative instances.

This may be carried out with a transformer architecture, which may start with object embeddings and propositional encoding. On top of those, we might have a series of attention mechanisms, together with feed-forward layers and regularization steps.

This may involve self-supervision, where the model's only objective is to learn from co-occurrence patterns in the sequences that it's trained on, in a distributional learning process. Here, the model is learning to assign high probability to attested sequences such as object tokens or “no object” tokens. These models are generators, and the generation involves sampling from the model. Generation is a secondary or derivative process, and the important thing is learning from co-occurrence patterns.

In this approach, images, object image pixel constellations, text, computer code, even sensor readings are all just symbol streams, and the model learns associations among them. This does require large quantities of training data, however. But more and more, that data is available, as in the case of large language models, which have progressed from about 110 million parameters in 2018 with OpenAI's first GPT, to 17 billion parameters in 2020 with Microsoft's T-NLG. The growth curves for machine vision and image training are also trending exponentially upward in recent years.

In some embodiments, the image generation model may be fine-tuned with human supervision making binary distinctions about good inferences or generations and bad ones, in an “instruct model.” Further, as the model generates outputs, humans may rank all of the outputs the model has produced, providing feedback for reinforcement learning mechanisms.

In some embodiments, a prompt may be provided to the system to facilitate its performance in generating a desired image. For example, a prompt may define a class of objects to generate or remove, such as a mask, eyeglasses, or a specific facial feature. Additional detail may be included in the prompt in terms of object selection for generation or removal, such as spatial dimensions of an object to be generated, color, texture, or other characteristic.

In some systems, a vector database is used to store information-rich vectors that numerically represent the meaning of contexts (e.g., classes of objects that are used to extract images that satisfy a query or selection).

A retriever model encodes queries and contexts into the same vector space. It is these context vectors that can be later stored in the vector database. The retriever also encodes queries to be compared to the context vectors in a vector database to retrieve the most relevant contexts.

In some embodiments, a retriever can be used as a tool for pulling in images and generating modified images with scores. A reader model can be used to take a query and context, and identify a span (sub-section) from the context which satisfies the query.

In a further implementation, an image AI may be linked to a language AI such as Chat GPT or Whisper (an automatic speech recognition (ASR) system). In this case, the language model may serve as a tool for pulling in text or voice and producing text with scores. This may aid in refining a selection or prompt, or make a selection, query, or request for an object-modified image possible via natural language queries.

In some embodiments, a retrieval-augmented approach may include having the retriever communicate with the language model via retrieved image results. In some embodiments, the system may work in both directions such that it is essentially constructed by prompts that help these models exchange messages between them in potentially very complicated ways to arrive at a desired result.

In some embodiments, the retriever may be used to find demonstration objects that are close to, e.g., provide context for, a user's selection or query for an image. Such demonstration objects may be used to enrich the query prompt with the expectation that it will help it understand topical coherence and lead to better results. For example, demonstration objects for eyeglasses generation may include examples of a certain frame style or lens coating, or sample plastic surgery images of noses for the generation of images of rhinoplasty.

Further, the retriever could be used to find relevant context images for each one of those demonstration objects to further help it figure out how to generate the desired image.

In some embodiments, the system may use hindsight retrieval, where for each query the system uses both the question and the answer to find relevant context images to provide integrated informational packets that the model can benefit from. See https://www.youtube.com/watch?v=-lnHHWRCDGk.

In some embodiments, the system may use a Retrieval Augmented Generation or RAG model, which essentially creates a full probability model that allows the system to marginalize out the contribution of certain passages or images. See https://arxiv.org/abs/2209.14491.

### Neural Radiance Field Embodiments

Neural radiance fields can be used to represent complex images or scenes given a set of input images of a scene. In these methods, a volumetric representation of the scene is optimized as a vector-valued function which is defined for any continuous 5d coordinate consisting of a location (x, y, z coordinates) and view direction (0, p). The scene representation is parameterized as a fully connected deep network that takes each single 5d coordinate and outputs the corresponding volume density and view-dependent emitted RGB radiance at that location. Volume rendering techniques are then used to composite these values along a camera array to render any pixel. This rendering is fully differentiable so the system is able to optimize the scene representation by minimizing the error of rendering all camera rates from a collection of standard RGB images.

Neural radiance fields exhibit some advantages over other techniques such as local light field fusion and scene representation networks. Neural radiance fields are able to represent fine details with complex occlusion effects such as eyeglass frames and lenses, masks, virtual facial features, and other face objects, including the removal of the above. Realistic effects include semi-transparent objects such as glasses lenses, specular areas on reflective surfaces, and sharp reflections and specularity on glass, metal, or plastic surfaces. These systems also capture high quality scene geometry such as high resolution details of facial features and complex occlusions of portions of the face. This geometry is precise enough to be used for additional graphics applications such as virtual object insertion with convincing occlusion effects, using relatively few input images, e.g., with only 20 to 50 input images neural radiance field representations are able to render photo realistic novel views of entire scenes with fine geometry details and realistic view-dependent reflectance effects. These systems capture all of this visual complexity in the weights of a fully connected neural network. See https: //www.matthewtancik.com/nerf, and Mildenhall et al, “NeRF: Representing Scenes as Neural Radiance Fields for View Synthesis,” arXiv:2003.08934, August, 2020.

### Facial Landmark Detection

In some embodiments, facial landmark analysis may be performed, for example to distinguish one viewer from another for the purpose of assigning unique identifiers to each viewer of a single display. Face data for analysis by the facial landmark detector may be obtained from any suitable source, as described above, such as images in a proprietary dataset or other image database. In one example, a facial landmark detector may perform farthest point sampling of the data for each session while using head rotation as the feature to sample. Data may include some variety of head poses, although most recordings use a frontal head pose. Data may also include faces from a wide variety of people. The dataset should include good image quality, a wide variety of head poses, a wide variety of people, and a wide variety of facial expressions. For example, YouTube videos may be used as training data.

An example data preparation process includes generating a ground truth by using a pre-trained landmark detector. Data preparation may also include generating emotion classification by using a pre-trained emotion recognition algorithm. Data preparation may also include computing a head pose using the detected landmarks.

In another example, the data may be filtered in such a way that only the images with “interesting” facial expressions are kept. The term “interesting” facial expressions as used in this context may include distinct expressions, common expressions, unusual expressions, or other category of expression depending on the desired output.

For each frame, the facial landmark detector may compute additional frames. For example, frames may be computed where the face bounding box is slightly moved in a random direction, in order to prevent the model from being limited to facial landmarks that are in the middle of a frame. Some frames that are sampled from the data may not have any faces in them. These frames may be used as negative examples to help the neural network understand the absence of a face.

As part of the training process, the facial landmark detector may use different data augmentation techniques. Example techniques may include random zoom in/out. This increases the model's ability to predict different face bounding box borders. Example techniques may also include random rotation. This increases the model's ability to predict different head poses. Example techniques may also include random translation. This also increases the model's ability to predict different head poses. Example techniques may also include impulse noise. This increases the model performance on noisy data. Example techniques may also include random illumination. This technique can be used to add an illumination effect to the image. Example techniques may also include a random black box as an obstruction or occlusion. This technique increases the model's ability to deal with occlusions.

In one example embodiment of the facial landmark detector model, the input to the model is a 192×192 one-channel image. The image includes a face. An output is generated with Nx2, where N is the number of landmarks the model outputs. For each landmark, the facial landmark detector model predicts its X,Y location in the input frame. The output is normalized between 0 and 1. A binary classifier predicts whether there is a face in the input frame, and outputs a score between 0 and 1.

The model architecture may include a common backbone that receives the image as input and produces an embedding of it. Landmarks may be split into different groups that share some similarities. Each head is fed by the common embedding, and outputs some subset of the landmarks. Each computed head has its own computation graph. Groups may include, for example, eyes, mouth, and exterior of the face. Using the groups helps the model to perform independent prediction of different facial landmark groups. These groups help the model to avoid biasing, do symmetry prediction, and compute some landmarks even though other landmarks are occluded. For example, the model works well on face images with masks, although the model never saw masks in the training process.

In some embodiments, the loss function is a variant of adaptive wing loss, but in some embodiments, the theta changes linearity during the training so the model is punished more on small errors as the training progresses. See Adaptive Wing Loss for Robust Face Alignment via Heatmap Regression; Xinyao Wang, Liefeng Bo, Li Fuxin; arXiv:1904.07399; https: //arxiv.org/abs/1904.07399; https: //doi.org/10.48550/arXiv.1904.07399; hereby incorporated by reference.

In an example, the failure rate of images can be determined based on the normalized mean error (NME) being larger than some value (e.g., 0.1). Frames with large NME are considered to be frames on which the prediction failed.

### Gaze Estimation Methods and Systems Using Deep Learning

As described in U.S. patent application Ser. No. 17/298,935 titled “SYSTEMS AND METHODS FOR ANATOMY-CONSTRAINED GAZE ESTIMATION,” incorporated by reference herein, real-time methods and systems using non-specialty cameras are disclosed for providing a point-of-regard (PoR) in a 3D space and/or 2D plane, based on user-personalized constrained oculometry (identified for each eye).

This is achieved, partly, through deep-learning-based, landmark detection of iris and pupil contours on recorded images obtained by the imaging module comprising an optical sensor that is directed toward the user, as well as deep-learning-based algorithm for estimating user's head pose with six (6) degrees of freedom (6DoF), namely localization in 3D space (x, y, z) and angular positioning (pitch, yaw, roll)). Additionally, geometrical and ray tracing methods can be employed to unproject the iris and pupil contours from the optic sensors in the imaging module's plane onto 3D space, thus, allowing the system to estimate the personalized, user-specific eye (used interchangeably with “eyeball”) location (based on an initial geometry eyeball-face model, that relates between visible feature such as facial-landmarks to non-visible features such as eyeball center, refraction index, corneal-eyeball deviation, etc.) and gaze direction in the imaging module's space (e.g., Cartesian) coordinate system (in other words, a system of representing points in a space of given dimensions by coordinates). Likewise, the term “Cartesian coordinate system” denotes a system where each point in a 3D space may be identified by a trio of x, y, and z coordinates. These x, y, and z coordinates are the distances to fixed X, Y and Z axes. In the context of the implementations disclosed, the 3D coordinate system refers to both the 3D position (x, y, z) and 3D orientation (pitch, roll, yaw) of the model coordinate system relative to the camera coordinate system.

The components used for the operation of the system can be, for example, an imaging module with a single optical (e.g., passive) sensor having known distortion and intrinsic properties, obtained for example, through a process of calibration. These distortion and intrinsic properties are, for example, modulation-transfer function (MTF), focal-length for both axes, pixel-size and pixel fill factor (fraction of the optic sensor's pixel area that collects light that can be converted to current), lens distortion (e.g., pincushion distortion, barrel distortion), sensor distortion (e.g., pixel-to-pixel on the chip), anisotropic modulation transfer functions, space-variant impulse response(s) due to discrete sensor elements and insufficient optical low-pass filtering, horizontal line jitter and scaling factors due to mismatch of sensor-shift- and analog-to-digital-conversion-clock (e.g., digitizer sampling), noise, and their combination. In an exemplary implementation, determining these distortion and intrinsic properties is used to establish an accurate sensor model, which can be used for calibration algorithm to be implemented.

As part of the analysis of the recorded image, the left or right eye region of the user can be defined as the region encompassing the corners of the eye as well as the upper and lower eyelids, having a minimal size of 100×100 pixels, in other words, each of the left, and right eyes' region comprises a quadrilateral polygon (e.g., a rectangle) of at least 100 pixels by 100 pixels extending between the corners of each eye as well as between the upper and lower eyelids, when the eye is open.

To build an accurate eye model, the locations of the iris of both eyes is established in a 3D coordinate system in which the eyeball center is fixed. The head pose coordinate system can serve as the basis for establishing the iris location. In an example, an eye-face model—the location of both eyeball centers is determined in head coordinates (with regard to facial landmarks). An example of a pseudo code for the algorithm of the eye-model building is:

### Eye Face Model Building Example

### Input:

{F}_{i=1 . . . N}—N Image Frames
C—Camera's Intrinsics, projection matrix and distortion coefficients
K—Camera Matrix

### Output

E_{L}, E_{R}—Left and Right Eyeball centers
IE_{L}, IE_{R}-iris—Eye center offsets

### Algorithm:

1. For each Frame, F
   a. ←IntrinsicDistortionCorrection(Fᵢ, C)
      Was done by multiplying with a camera projection matrix in order to bring the data to a similar form to what the network knows how to handle.
   b. {LP}_{j,eye}, R_{H}, T_{H}, Landmarksᵢ←HeadposeLandmarkIrisDetection(\tilde{F}ᵢ)
      Was done by deep neural networks. R_{H}, T_{H} denote head rotation and translation respectively.
   c. For each eye:
      i. ProjectedIrisEllipse(a,b,ϕ,x_{c},y_{c})←EllipseFitting({LP}_{j,eye})
   The iris was estimated as a circle mapped to an ellipse by the camera's projection:
      ii. IrisCone_{CCS}←Unproject(ProjectedlrisEllipse, K) (307a)—Produces a cone in Camera's Coordinate System which is the result of multiplying the projected ellipse points with the inverse of the camera projection matrix (each point is mapped to a line in 3D).
      iii. IrisCone_{HCS}—ApplyRotationTranslation(R_{H}, T_{H}, IrisCone_{CCS})
         This stage was done to bring the cone (and by extension the Iris circle) to a coordinate system in which the eyeball center is fixed {3DIrisCircle_{HCS}}₊,←CircularConelntersection(IrisCone_{HCS}, r₁)

As specified in the step (i) hereinabove; the Iris circle was brought to a coordinate system in which the eyeball center was fixed, which was done assuming that the iris is a circle positioned on the surface of the eyeball sphere (which projection results in the ellipse detected by the camera). Thus the circular intersections with the cone, were its possible locations; and using rI=6 mm—population mean (of iris' dimensions) resulted in 2 possible iris circles—denoted+,−. The Iris(Circle) rotation angles were then denoted η, ξ.

2. {E, reye}Eye∈L,R′i←Swirsky ({{3DIrisCircleHCS}+,−}i=1N)

An initial guess for eyeball centers and Radii was achieved using the algorithm specified in [2]—for each eye the Iris circles was found, which a normal vector intersects in a single point, and that point. The eyes' rotations (i) was also obtained-which are the Iris circle normal in the head coordinate system:

In this step, the (rotated) eye model was obtained from the head coordinate system and the projection operator was computed by first applying rotation and translation with RH−1, -TH followed by multiplication with the camera projection matrix K of the 3D eye, while Ri was the established eye rotation in every frame Fᵢ—also applied using matrix multiplication of the simplified 3D eye model (a sphere of radius r_{eye} with limbus in radius IE centered at ER,L). These parameters defined the (hidden from camera) eyeball center positions with regard to head-pose, and thus mapping to the facial landmarks which allowed the inference of the eyeball center from the camera-detected visible landmarks.

The process was repeated for both eyes resulting in EL, ER, IEL, IER leading to a personalized parameter of the locations of both eyes as related to each other, constrained anatomically by the eyeball centers.

For example, the algorithm used for eye region localization can comprise assigning a vector to every pixel in the edge map of the eye area, which points to the closest edge pixel. The length and the slope information of these vectors can consequently be used to detect and localize the eyes by matching them with a training set (obtained ion the intrinsic calibration phase). Additionally, or alternatively, a multistage approach may be used for example to detect facial features (among them are the eye centers, or pupils) using a face detector, with pairwise reinforcement of feature responses, and a final refinement by using an active appearance model (AAM). Other methods of eye region localization can be employed, for example: using edge projection (GPF) and support vector machines (SVMs) to classify estimates of eye centers using an enhanced version of Reisfeld's generalized symmetry transform for the task of eye location, using Gabor filters, using feature triplets to generate a face hypothesis, register them for affine transformations, and verify the remaining configurations using two SVM classifiers, and using an eye detector to validate the presence of a face and to initialize an eye locator, which, in turn, refines the position of the eye using the SVM on optimally selected Haar wavelet coefficients. These methods can be used either alone or in combination with the face detection algorithm.

The face detection algorithm may be further used to compute head pose in six degrees of freedom (6DoF). Some exemplary methods for estimating head pose localization and angular orientation can be a detector array method (DAM), in which a series of head detectors are trained, each configured to classify a specific pose and assign a discrete pose to the detector with the greatest support, a technique using machine learning and neural networks. This method can be supplanted or replaced by Nonlinear Regression Methods (NRM), which estimates head pose by learning a nonlinear functional mapping from the image space to one or more pose directions, normally using regression tools and neural networks. Additional methods can be, for example: a flexible algorithm, in which a non-rigid model is fit to the facial structure of the user in the image and wherein head pose is estimated from feature-level comparisons or from the instantiation of the parameters, using the location of extracted features such as the eyes, mouth, and nose tip to determine pose from their relative configuration, recovering the global pose change of the head from the observed movement between video frames then using weighted least squares on particle filtering to discern the head pose. In an exemplary implementation, the head pose determination method used may be a hybrid method, combining one or more of the aforementioned methods to overcome the limitations inherent in any single approach. For example, using local feature configuration (eyes, nose tip, lips, e.g.,) and sum of square differences (SSD) tracking, or principal component analysis comparison and continuous density hidden Markov modeling (HMM). The existing models are additionally extended to include, for example eyeball landmarks, both visible (e.g., pupil-center, pupil contour and limbus contour) as well as non-visible (e.g., eyeball center, iris-corneal offset, cornea major axis). These are determined through a calibration process between the visible facial-eye landmarks (or feature) to the non-visible face-eye landmarks (or features) through a process of fixation, or focusing, by a subject on a known target presented to the subject. The final outcome of this procedure is a personalized face-eye model (which is configured per-user) that best estimates the location of the visible and non-visible landmarks (or features) in the sense of Gaze-reprojection (matrix)-error (GRE).

In an exemplary implementation, using DNN architecture of stacked hourglass is used because of the need to make the system user specific, implying the ability to capture data over numerous (application-specific) scales and resolutions. Thus, the DNN can consist of, for example, at least three (3) Stacked Hourglass heat-maps, in three pipelines; one for the face (a scale larger than the eyes landmark localizing), left eye, and right eye modules (L and R eyes—same scale), with an input of eyes region image, each of at least the size 100 by 100 pixels in another implementation.

In the context of the disclosed methods, systems and programs provided, the term “stacked hourglass” refers in some implementations to the visualization of the initial sampling followed by the steps of pooling and subsequent convolution (or up-sampling) used to get the final output of the fully connected (FC) stack layers. Thus, the DNN architecture is configured to produce pixel-wise heat maps, whereby the hourglass network pools down to a very low resolution, then reconvolutes and combines features across multiple resolutions.

In an exemplary implementation, for each eyeball region that was successfully located by the detection algorithm, the DNN outputs the subject's iris and pupil elliptical contours, defined by the ellipse center, radii of ellipse, and their orientation. In addition, for each face image that was successfully located by the detection algorithm, the DNN outputs the subject's head location in 3D space (x, y, z, coordinates) in the camera coordinate system as well as the subject's roll, yaw, and pitch. Additionally, another DNN receives as an input the face region to train on estimating the gaze direction and origin. This DNN consists of a convolutional layer, followed by pooling, and another convolution layer which is then used as input to a fully connected layer. The fully connected layer also obtains input from the eye-related DNN.

The instant gaze direction (interchangeable with gaze estimation, point of reference or point-of-regard (PoR)) system is of high-precision (less than 1 degree of error accuracy referring to the angular location of the eye relative to the optic sensor array).

Acquiring eye region image data may be done via at least one camera associated with a digital display. Any suitable camera may be provided, including but not limited to cameras for recording or processing image data, such as still images or video images. Accepting eye region image data may be performed by a camera at a distance of at least 0.2 meters from at least one of the plurality of viewers. Suitable distances may include acquiring eye region image data at a distance from about 0.2 meters to about 3 meters. In some implementations, by way of non-limiting example, accepting eye region image data may be performed by at least one of a laptop camera, a tablet camera, a smartphone camera, a digital billboard camera, or a digital external camera. A smartphone camera may be any camera provided with a mobile device such as a mobile phone or other mobile computing device. A digital external camera may include any other stand-alone camera including but not limited to a surveillance camera, or a body-mounted camera or wearable camera that can be mounted or otherwise provided on the viewer (e.g., on glasses, a watch, or otherwise strapped or affixed to the viewer). In some implementations, acquiring eye region image data may be performed with active illumination. In other implementations, acquiring eye region image data may be performed without active illumination. Active illumination may include a camera flash and/or any other suitable lighting that is provided for the purpose of image capture separate and apart from artificial or natural lighting of the surrounding environment. By way of non-limiting example, the eye region image data may include at least one of pupil image data, iris image data, or eyeball image data.

For example, pupil image data, iris image data, and eyeball image data may be obtained from images of the viewer. Pupil image data may refer to the data regarding the viewer's pupil, or the darker colored opening at the center of the eye that lets light through to the retina. Iris image data may refer to data regarding the viewer's iris, or the colored part of the eye surrounding the pupil. Eyeball image data may refer to data regarding any portion of the viewer's eyeball, including the sclera, the limbus, the iris and pupil together, or the area within the neurosensory retina (the portion of the macula responsible for capturing incident light).

In some embodiments, the methods and systems of the instant application may involve analyzing eye region image data to determine at least one 3D eye position, at least one gaze angle, or at least gaze direction for at least one viewer relative to at least one camera associated with a digital display. The at least one gaze angle may include yaw and pitch. This analyzing may include mapping the eye region image data to a Cartesian coordinate system. By way of non-limiting example, analyzing the eye region image data may include unprojecting the pupil and limbus of both eyeballs onto the Cartesian coordinate system to give 3D contours of each eyeball. The limbus forms the border between the cornea and the sclera (or “white”) of the eyeball.

In some embodiments, a distance may be calculated from at least one camera to at least one viewer using image analysis. Any suitable image analysis may be implemented, such that meaningful information is extracted from digital images via algorithmic analysis and processing of data captured by the camera(s).

Yet another aspect of the present disclosure relates to a non-transient computer-readable storage medium having instructions embodied thereon, the instructions being executable by one or more processors to perform a method for generating realistic augmented face images.

Still another aspect of the present disclosure relates to systems configured for generating realistic augmented face images. The system may include means for receiving head pose data, segmented eye region image data, eye position data, gaze direction data, and face and eye landmark data from an individual. The system may include means for receiving a user selection of a facial object to be added or removed from an image of the individual. The system may include means for using a deep learning model, a) generating one or more images of the individual with the facial object in place on the one or more images, or b) generating one or more images of the individual with the facial object removed from the one or more images, wherein the generated one or more images of the individual with the facial object in place or removed includes an inference of facial object appearance or disappearance derived from the deep learning model; and wherein the deep learning model was trained at least in part on head pose data, face and eye landmark data, eye position data, gaze direction data, segmented eye region image data, and facial object information.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

Those having ordinary skill in the art will recognize that the state of the art has progressed to the point where there is little distinction left between hardware, software, and/or firmware implementations of aspects of systems; the use of hardware, software, and/or firmware is generally a design choice representing cost vs. efficiency tradeoffs (but not always, in that in certain contexts the choice between hardware and software can become significant). Those having ordinary skill in the art will appreciate that there are various vehicles by which processes and/or systems and/or other technologies described herein can be affected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be affected, none of which is inherently superior to the other in that any vehicle to be utilized is a choice dependent upon the context in which the vehicle will be deployed and the specific concerns (e.g., speed, flexibility, or predictability) of the implementer, any of which may vary.

In some implementations described herein, logic and similar implementations may include software or other control structures suitable to operation. Electronic circuitry, for example, may manifest one or more paths of electrical current constructed and arranged to implement various logic functions as described herein. In some implementations, one or more medias are configured to bear a device-detectable implementation if such media hold or transmit a special-purpose device instruction set operable to perform as described herein. In some variants, for example, this may manifest as an update or other modification of existing software or firmware, or of gate arrays or other programmable hardware, such as by performing a reception of or a transmission of one or more instructions in relation to one or more operations described herein. Alternatively, or additionally, in some variants, an implementation may include special-purpose hardware, software, firmware components, and/or general-purpose components executing or otherwise controlling special-purpose components. Specifications or other implementations may be transmitted by one or more instances of tangible or transitory transmission media as described herein, optionally by packet transmission or otherwise by passing through distributed media at various times.

Alternatively, or additionally, implementations may include executing a special-purpose instruction sequence or otherwise operating circuitry for enabling, triggering, coordinating, requesting, or otherwise causing one or more occurrences of any functional operations described above. In some variants, operational or other logical descriptions herein may be expressed directly as source code and compiled or otherwise expressed as an executable instruction sequence. In some contexts, for example, C++ or other code sequences can be compiled directly or otherwise implemented in high-level descriptor languages (e.g., a logic-synthesizable language, a hardware description language, a hardware design simulation, and/or other such similar modes of expression). Alternatively or additionally, some or all of the logical expression may be manifested as a Verilog-type hardware description or other circuitry model before physical implementation in hardware, especially for basic operations or timing-critical applications. Those skilled in the art will recognize how to obtain, configure, and optimize suitable transmission or computational elements, material supplies, actuators, or other common structures in light of these teachings.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those having ordinary skill in the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a USB drive, a solid state memory device, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read-only, etc.)), and/or electrical circuitry forming a communications device (e.g., a modem, communications switch, optical-electrical equipment, etc.). Those having ordinary skill in the art will recognize that the subject matter described herein may be implemented in an analog or digital fashion or some combination thereof.

Those skilled in the art will recognize that at least a portion of the devices and/or processes described herein can be integrated into a data processing system. Those having ordinary skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

In certain cases, use of a system or method as disclosed and claimed herein may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory.

Further, implementation of at least part of a system for performing a method in one territory does not preclude use of the system in another territory.

All of the above U.S. patents, U.S. patent application publications, U.S. patent applications, foreign patents, foreign patent applications and non-patent publications referred to in this specification and/or listed in any Application Data Sheet, are incorporated herein by reference, to the extent not inconsistent herewith.

One skilled in the art will recognize that the herein described components (e.g., operations), devices, objects, and the discussion accompanying them are used as examples for the sake of conceptual clarity and that various configuration modifications are contemplated. Consequently, as used herein, the specific examples set forth and the accompanying discussion are intended to be representative of their more general classes. In general, use of any specific example is intended to be representative of its class, and the non-inclusion of specific components (e.g., operations), devices, and objects should not be taken to be limiting.

With respect to the use of substantially any plural and/or singular terms herein, those having ordinary skill in the art can translate from the plural to the singular or from the singular to the plural as is appropriate to the context or application. The various singular/plural permutations are not expressly set forth herein for sake of clarity.

The herein described subject matter sometimes illustrates different components contained within, or connected with, different other components. It is to be understood that such depicted architectures are presented merely as examples, and that in fact many other architectures may be implemented which achieve the same functionality. In a conceptual sense, any arrangement of components to achieve the same functionality is effectively “associated” such that the desired functionality is achieved. Therefore, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of “operably couplable” include but are not limited to physically mateable or physically interacting components, wirelessly interactable components, wirelessly interacting components, logically interacting components, or logically interactable components.

In some instances, one or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components, inactive-state components, or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such a recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having ordinary skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having ordinary skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented as sequences of operations, it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A computer-implemented method for removing an object from one or more images of a face, the method comprising:
accepting face digital image data of a user, wherein the face digital image data includes at least head pose data, face and eye landmark data, eye position, and gaze direction data;
accepting segmented eye region image data of the user;
accepting facial object information;
using the face digital image data, the segmented eye region image data, and the facial object information to train a deep neural network to encode and decode at least one face object region; wherein the deep neural network is operable to replace at least one face region image having a face object with a face region image without the face object post-training;
receiving inference head pose data, inference segmented eye region image data, eye position data, gaze direction data, and inference face digital image data from an individual;
receiving a user selection of at least one inference facial object; and
generating one or more images of the individual without the inference facial object, wherein the one or more images of the individual without the inference facial object includes an inference of face appearance derived from the deep neural network based on the user head pose data, segmented eye region image data, face digital image data, and the user selection of at least one inference facial object.

2. The computer-implemented method of claim 1, wherein the head pose data comprises at least one of pan data, tilt data, or pan-tilt data pairs.

3. The computer-implemented method of claim 1, wherein the eye landmark data comprises iris image data and outer region of the eye image data.

4. The computer-implemented method of claim 1, wherein the gaze direction data comprises at least one of gaze angle data or point-of-regard data.

5. The computer-implemented method of claim 1, wherein the face digital image data comprises at least one of eye region image data, eyeglasses lens region image data, or whole face image data.

6. The computer-implemented method of claim 1, wherein the accepting segmented eye region image data of the user comprises accepting segmented eyeglasses lens region image data of the user.

7. The computer-implemented method of claim 6, wherein the accepting segmented eyeglasses lens region image data of the user comprises accepting at least one estimated size of the lens region image data.

8. The computer-implemented method of claim 1, wherein the segmented eye region image data is received by a camera that is proximate to the display viewed by the user.

9. The computer-implemented method of claim 1, wherein the accepting facial object information comprises accepting at least one of eyeglasses information, facial hair information, face covering information, or plastic surgery information.

10. The computer-implemented method of claim 9, wherein the accepting eyeglasses information comprises accepting information about at least one of eyeglasses frame size, eyeglasses frame color, eyeglasses frame shape, eyeglasses lens size, eyeglasses lens color, eyeglasses lens coating type, eyeglasses lens shape, eyeglasses lens refraction properties, or eyeglasses lens opacity.

11. The computer-implemented method of claim 9, wherein the accepting face covering information comprises accepting information about at least one of mask size, mask color, mask texture, mask pattern, or mask composition.

12. The computer-implemented method of claim 9, wherein the accepting plastic surgery information comprises accepting information about at least one of nose appearance, lip appearance, jawline appearance, neck appearance, eye region appearance, face appearance, brow appearance, skin appearance, or forehead appearance.

13. The computer-implemented method of claim 1, wherein the at least one facial object characteristic comprises at least one eyeglasses characteristic.

14. The computer-implemented method of claim 13, wherein the at least one at least one eyeglasses characteristic comprises at least one of a frame color, a texture, or a reflection of at least one eyeglasses lens region.

15. The computer-implemented method of claim 1, wherein the at least one face object region comprises at least one of a facial hair region, a face covering region, or a plastic surgery region.

16. The computer-implemented method of claim 1, wherein the receiving a user selection of an inference facial object comprises receiving a user selection of a pair of eyeglasses and at least one of a lens type or a lens coating type.

17. The computer-implemented method of claim 1, wherein the receiving a user selection of an inference facial object comprises receiving a user selection of at least one of a facial hair feature, a face covering, or a plastic surgery effect.

18. The computer-implemented method of claim 1, wherein the generating an image of the individual without the inference facial object comprises generating an image of the individual without a pair of eyeglasses.

19. A system comprising one or more processors configured to carry out the operations of claim 1.

20. A computer program product comprising a non-transitory computer-readable medium having instructions that, when executed by a computer, cause the computer to perform the operations of claim 1.
